(19) United States
(12) Patent Application Publication
(10) Pub. No.: US 2013/0061739 A1
(43) Pub. Date: Mar. 14, 2013

(54) ENERGY DISSIPATION COMPOSITE MATERIAL

(71) Applicants: Wun Chet Davy Cheong, Singapore (SG); Beng Chye Vincent Tan, Singapore (SG); Khant Phyo, Singapore (SG)

(72) Inventors: Wun Chet Davy Cheong, Singapore (SG); Beng Chye Vincent Tan, Singapore (SG); Khant Phyo, Singapore (SG)

(21) Appl. No.: 13/578,605

(22) PCT Filed: Feb. 11, 2010
(86) PCT No.: PCT/SG2010/000054

§ 371 Date: Nov. 20, 2012

(51) Int. Cl. F41H 5/04; F41H 7/02; B32B 5/02; B32B 5/18; B32B 5/26; B32B 7/12; F41H 1/02; B32B 37/14

(52) U.S. Cl. 89/36.02; 156/280; 428/304.4; 428/311.51; 428/317.1; 428/317.7; 428/76

(57) ABSTRACT

A composite material able to dissipate the kinetic energy of a moving object comprising a layer of ballistic material bonded to a layer of porous matrix material which is impregnated with shear thickening fluid.

### FIELD OF THE INVENTION

The present invention relates to a composite material that is able to dissipate the kinetic energy of a moving object, respective articles and uses thereof.

### BACKGROUND OF THE INVENTION

A wide range of protective materials are currently available in the market for preventing injuries due to ballistic or stab threats. Examples of these protective materials include body armour, bullet proof vests and flexible trauma pads. Excessive deformation of a bullet proof vest after impact can lead to serious injury to the human body (backface signature or blunt trauma injuries). Such injuries can sometimes be fatal depending on the position of the injury. In addition, the injured person might enter a state of shock and will not be able to respond quickly to threat. The solution to this is usually to insert a high molecular weight polyethylene, metal or ceramic plate behind the bullet proof vest.

The use of materials such as high strength aramid fabrics or high molecular weight polyethylene film is increasingly common in ballistic materials. Although high strength aramid fabrics or high molecular weight polyethylene film are strong enough to stop penetration by high speed projectiles, these flexible materials are still subjected to large deformation when impacted by the high speed projectile. This results in deep impressions in the body behind the fabric or protective film and therefore reduces the effectiveness of these materials in their application as soft body armour. Furthermore, because such plates are rigid, they can only be placed at places where mobility is not required (for example the chest).

To increase mobility of the user, flexible trauma pads made of ballistic fabric are also available in the market. However, the protection they offer is incomparable to the hard plates. These limitations of currently available impact absorption materials impede the development of a much needed effective full body armour.

There is an increasing interest in using shear thickening fluid for ballistic applications. The shear thickening fluid refers to any fluid that exhibit an increase in viscosity when increasing shear rate or applied stress. Due to its unique property of being a flowable liquid whose viscosity increases only during shear or stress, it offers the potential of providing flexible and conformable protective materials, when incorporated into ballistic materials.

US Patent Publication No. US 2009/0004413 A1 discloses a way of enhancing the impact dissipation ability of shear thickening fluid by the addition of discrete, non continuous fibres/fillers into the fluid. However, the addition of such fillers may only increase the shear thickening in a localized area of the fluid, and not throughout the fluid. Therefore, the localized dissipation of the impact energy may not be sufficient to protect the user from injuries.

U.S. Pat. No. 6,319,862 discloses a system used in ballistic vest which consists of a first plurality of penetration resistant material of high strength, such as aramid fabric, followed by a first plurality of backing layers polyethylene behind the aramid fabric layers. However, the flexibility of the system may be reduced since it requires many plies of materials being adhered together.

Therefore, there remains a need to develop a flexible composite material that effectively dissipates high impact energy, without compromising on mobility.

### SUMMARY OF THE INVENTION

In one aspect, there is provided a composite material that is able to dissipate the kinetic energy of a moving object, comprising or consisting of a layer of ballistic material bonded to a layer of porous matrix material.

In another aspect, there is provided a process for making the composite material. The process includes bonding a layer of ballistic material with a layer of porous matrix material.

In yet another aspect there is provided use of the composite material for dissipating the kinetic energy of a moving object.

In a further aspect, there is provided an article for dissipating the kinetic energy of a moving object comprising the composite material.

### DETAILED DESCRIPTION OF THE INVENTION

The composite material according to the present invention provides advantages such as high flexibility, high conformability and high impact energy dissipation, and yet can be easily manufactured. The composite material described herein is exceptionally useful in ballistic applications, such as a flexible blunt trauma pad or a ballistic vest. The conformability of the material also implies that it can be worn over areas of the body where mobility is essential (such as the knees, elbow and abdomen). Therefore, the composite material of the present invention can offer improved blunt impact protection than other known ballistic protective materials available in the market today.

The present invention provides a composite material that is able to dissipate the kinetic energy of a moving object. The composite material includes or consists of a layer of ballistic material bonded to a layer of porous matrix material.

The term “porous matrix material” as used herein refers to any material having a plurality of pores or openings within the material. The porous matrix material is capable of receiving a fluid through the pores and/or allow the fluid to pass through the pores. The porous matrix material can, for example be a woven material, non-woven material or a sheet/web containing fibres. The porous matrix material may contain a plurality of fibres that can be interlocked or bonded to one another, or the fibres can otherwise be unbonded.

The term “woven” when used herein with reference either to the porous matrix material or to the ballistic material, refers to any material that is formed by weaving. In this context, a woven material can, for example be characterized by a particular or differential weave in which the strand denier or warp/weft pick count is specified. For example, when the strands are woven in a plain weave characterized by a regular, one-to-one interlacing of strands, each strand can be aligned in a first direction, for example, warp direction, which moves alternatively over and under adjacent strands aligned in a second direction, for example, weft direction. In this context, the term “warp” used in the regular meaning in the art refers to the set of lengthwise yarns through which the “weft” is woven. Therefore, the term “weft” refers to the yarn which is drawn under and over the parallel warp yarns in order to create the woven material. The woven material may also have any known weave, such as a basket weave, a rep or rib weave, a twill weave, a satin weave, or a double weave.

The term “non-woven” as used herein with reference either to the porous matrix material or to the ballistic material, refers to a plurality of individual fibres which are interlaid in a random distribution, typically in the form of a web and not in an identifiable repeating manner such as a knitted fabric. The non-woven material, for example a felt, can be manufactured using any thermal or chemical means within the knowledge of the person of average skill in the art. Examples of manufacturing the non-woven material can include, but are not limited to, meltblowing processes, spunbonding processes, spunlaced processes and bonded carded web processes. Exemplary non-woven materials may include, for example, a spunbond fabric. A spunbond fabric may be understood herein as including filaments or fibres which may be extruded, drawn and laid on a moving belt to form a web. The spunbond fabric may then be bonded via a number of bonding methods, such as by chemical, thermal, mechanical, ultrasonic or a combination thereof. Other exemplary non-woven materials can include “MASSLINN” non-woven fabrics, which are described in for example, U.S. Pat. No. 2,705,687; “KEYBAK” bundled non-woven fabrics which are described in for example, U.S. Pat. Nos. 2,862,251 and 3,033,721; and “isotropic” non-woven fabrics which are described in, for example U.S. Pat. No. 2,676,363.

The term “fibre” as used herein is a type of material that is defined as a relatively flexible, macroscopically homogenous body having a high ratio of length to width across its cross-sectional area perpendicular to its length. The fibres can be of any suitable length, for example, from approximately about 1 cm to about 10 cm. The fibre cross-section can be of any shape, but is typically round. In this context, the non-woven material can, for example, be a fibrous material comprising any suitable types of fibres or mixtures thereof, that are within the knowledge of the person of average skill of the art. Examples of such fibres can include a polymer, such as polypropylene; polyethylene such as low density polyethylene (LDPE); polymethylpentene; polybutene; poly(4-methyl-1-pentene); polyester such as polybutylene terephthalate or combinations thereof. Other exemplary fibres can include acrylic fibres such as Acrilan (Chemstrand) and Orlon (DuPont). In some embodiments, the porous matrix material can comprise polyester. Examples of polyester matrix material can be commercially available and are for example, obtained from Breather Fire Retardant RC3000-10AFR or RC 3000-10A, sold by Richmond Aircraft Products, Inc, USA, or polyester spunbond contine filament non-woven geotextile having an open pore size of 0.01 to 0.2 mm, obtained from Jiangsu Broad Pioneer Textile Associated Co., Ltd, China. Other exemplary polyester matrix material that can be used includes Dacron (DuPont), Diolen (Swicofil), Frotrel (Wellman Inc) and Kodel (Eastman), as described in U.S. Pat. No. 3,720,562.

Other fibres that can be used in the porous matrix material, can include natural fibres, for example, wool, cotton, hemp, wood, or combinations thereof, as long as they contain a plurality of openings within the material, which permit fluid to be introduced or passed through. When desired, any natural fibres can be combined with any suitable fibres mentioned above for the porous matrix material. Examples of such porous matrix material can include, but are not limited to polyester wool, polyester cotton, hemp fibre reinforced polyester composites, wood fibre reinforced polypropylene matrix composites, cotton fibre reinforced polypropylene composites, or combinations thereof.

The term “ballistic (fibre) material” as used herein refers to any suitable material which can include fibrous or non-fibrous material, capable of absorbing or resisting the impact of a moving object, such as a projectile. The ballistic material as described herein is intended to stop, or at least severely retard, the progress of a projectile; although it may not be completely impenetrable to all types of projectiles under different situations.

A ballistic fibre material can for example comprise high modulus polymeric fibres. Examples of such high modulus polymeric fibres can include but are not limited to polyamide, polyolefin, polyimide, poly (p-phenylene-2,6-benzobisoxazole) (PBO) ZYLON®, or combinations thereof. A ballistic fibre material can also comprise a carbon fibre derived from polyacrylonitrile fibres (PAN), pitch resins, or rayon; carbon nanotube reinforced polymer; glass reinforced polymer such as silica (SiO₂) or combinations of SiO₂, Al₂O₃, B₂O₃, CaO, or MgO; ceramic whisker such as boron carbide ceramic fibre; microcrystalline cellulose or combinations thereof.

In this context, the polyamide that can be used to form a ballistic fibre material can comprise aramid, or nylon or combinations thereof. Examples of an aramid that can be used include, but are not limited to KEVLAR®; TWARON®; TECHNORA®; NOMEX®; TEIJINCONEX®; or combinations thereof. KEVLAR® is available from E. I. du Pont de Nemours and Company and consists of long molecular chains produced from poly-paraphenylene terephthalamide. KEVLAR® is a polyamide, in which all the amide groups are separated by para-phenylene groups. That is, the amide groups attach to the phenyl rings opposite to each other, at carbon positions 1 and 4. Examples of KEVLAR® can include KEVALAR® 29, KEVLAR® 49, or combinations thereof. Another example of an aramid that is suitable for use as a ballistic fibre material is TWARON®. TWARON® is a lightweight fibre of high tensile strength and is made from aramid polymer that is available from Teijin. TECHNORA® (Teijin) is a para-aramid (co-poly-(paraphenylene/3,4′-oxydiphenylene terephthalamide) that can also be suitable to form a ballistic fibre material. NOMEX® and TEIJINCONEX® are meta-aramids and are respectively available from E. I. du Pont de Nemours and Company and Teijin. Other suitable aramid composites suitable for use include Gold Flex® (Honeywell), which is a unidirectional aramid fibre-reinforced thermoplastic sheet. Examples of nylons that are suitable as a ballistic fibre material can, for example, include CORDURA® (DuPont).

Alternatively and/or additionally, any suitable polyolefin that is capable of absorbing or resisting the impact of a moving object can be used to form the ballistic material. Such polyolefin can, for example, include ultra high molecular weight polyethylene (UHMWPE), also known in the art as high modulus polyethylene, or high density polyethylene (HDPE), or high modulus polypropylene such as Innegra S® (Innegrity LLC) or combinations thereof. UHMWPE comprises extremely long chains of polyethylene and is suitable for use as a ballistic fibre material due to its high tensile strength and modulus properties. Examples of UHMWPE include SPECTRA® (Honeywell Corp) and Dyneema® (DSM). SPECTRA® is an ultra lightweight, high-strength polyethylene material which is suitable for use as a flexible ballistic fibre material or high impact composite applications for example. SPECTRA® has high damage tolerance, non-conductivity, flexibility, high specific modulus and high energy-to-break, low moisture sensitivity, and good UV resistance. Examples of SPECTRA® that are available are SPECTRA® Fiber 900, SPECTRA® Fiber 1000 and SPECTRA® Fiber 2000. Dyneema® is a strong polyethylene fibre that offers maximum strength combined with minimum weight. In this context, Dyneema® is known in the art to be up to 15 times stronger than quality steel and up to 40% stronger than aramid fibres, both on weight for weight basis. Dyneema® floats on water and is extremely durable and resistant to moisture, UV light and chemicals. Other exemplary ballistic materials including the ones mentioned above are also described in U.S. Pat. No. 7,226,878, US Patent Publication No. US 2009/0004413 A1 and U.S. Pat. No. 6,319,862.

When desired, any polymeric fibres mentioned above can be combined with another polymeric fibre or with any natural fibre to form the ballistic material. Non-limiting examples of such ballistic material can include aramid and cotton blend, aramid fibre reinforced UHMWPE, aramid and polypropylene blend, or combinations thereof.

In some embodiments, the ballistic material described herein may be in the form of a knitted fabric, a woven fabric, a non woven fabric, a uniweaved structure, a uni-directional sheet, or a multi-directional sheet. The term “knitted fabric” when used herein refers to any two-dimensional open-meshed or loop-containing textile goods by any suitable textile method it may be produced. The term “uni-directional sheet” or “uni-directional fabric” when used herein refers to a sheet or fabric made with a weave patterned designed for directional strength in one direction only.

The term “bonded” when used in the context of the present invention refers to the adhesion of a layer of ballistic material bonded to a layer of porous matrix material. Illustratively speaking, by so doing, the two layers form a stack of the composite material of the present invention. When desired, the composite material of the present invention can also comprise any numbers of stacks of such composite material, in which repeated layers of the ballistic material bonded to the respective layers of the porous matrix material can be obtained. The composite material of the present invention can have for example, 2, 3, 4, 5, or even more layers of ballistic material bonded to the respective 2, 3, 4, 5 or even more layers of porous matrix material, depending on the desired use or the thickness of the composite material. The composite material can be of any thickness and usually depends only on the number of layers of ballistic material bonded to the respective number of layers of porous matrix material (or number of stacks of the composite material of the present invention). For example, 3 stacks of composite material of the present invention, in which 3 layers of ballistic material are bonded to the respective 3 layers of porous matrix material, can have a thickness of 2 cm. In this context, the inventors have surprisingly found that the composite material of the present invention results in a significant reduction of deformation on the composite material, when subjected to ballistic impact. Therefore, the composite material effectively reduces blunt trauma, without compromising on flexibility and mobility.

Any suitable adhesives that are within the knowledge of the person skilled in the art can be used, so long as the adhesive holds the ballistic material and the porous matrix material permanently together. Examples of such adhesives can include, but are not limited to polyurethane, polyvinyl acetate, epoxy, cyanoacrylate or combinations thereof. In some embodiments, when the ballistic material is brought into contact with the porous matrix material, epoxy or cyanoacrylate can be used to bond the ballistic material to the porous matrix material. In this context, the inventors have surprisingly found that the use of the adhesive in bonding the ballistic material and the porous matrix material together significantly reduces deformation of the composition material, during high ballistic energy impact (See Example 5, FIG. 6).

In some embodiments, the present composite material can include a fluid. The term “fluid” when used herein includes liquids and may include solids mixed in or dispersed in said liquids. The fluid can be an aqueous solution, for example, water, or a shear thickening fluid. The “shear thickening fluid” used in the regular meaning in the art refers to fluid that exhibits an increase in viscosity with increasing shear or applied stress. The shear thickening fluid can be any known shear thickening fluid, for example, as described in WO Publication WO2004/103231. The shear thickening fluid usually contains particles suspended in a media. The particles used in the shear thickening fluid can be made of various materials, such as organic or inorganic particles. The particles used herein can be stabilized in solution or dispersed by charge, Brownian motion, adsorbed surfactants, adsorbed or granted polymers, polyelectrolytes, polyampholytes, oligomers, or nanoparticles. The particles can be of any shape but typically include spherical particles, elliptical, biaxial, rhombohedral, cubic, rod-like particles, disk-like, clay particles, or a mixture of the above. These particles can be monodisperse, bidisperse or polydisperse in size and shape. Examples of these particles can include, but are not limited to oxides, corn starch, calcium carbonates, minerals, polymers or combinations thereof. Exemplary oxides can include, but are not limited to silicon dioxide, titanium oxide, silver oxide, zinc oxide, palladium oxide or combinations thereof. The minerals used herein can be naturally occurring or synthetic occurring minerals. Examples of minerals can, for example, include quartz, calcite, talc, gypsum, kaolin, mica, silicon carbide or combinations thereof. Non-limiting examples of polymer particles can include poly(methyl methacrylate) or polystyrene or combinations thereof.

The media that is used for the fluid can be aqueous-based, for example, water. The aqueous based media can contain a salt such as sodium chloride, caesium chloride, or mixtures thereof, for electrostatically stabilized or polymer stabilized particles. The media can also be organic-based, for example, ethylene glycol, polyethylene glycol, ethanol or combinations thereof. The media can be silicon-based, for example, silicon oil, phenyltrimethicone or combinations thereof. In case corn starch is used in the fluid, an anti-bacterial agent such as chloroxylenol or chlorohexidine diacetate can be added in order to ensure that the medium does not decompose over time. In further embodiments, hydrocarbon or fluorocarbon media can also be used.

Typically, the particles used in the fluid may have sizes less than the sizes of the openings of the porous matrix material. These particles can, for example, be introduced into the pores of the porous matrix material, or can pass through the pores of the porous matrix material. In some embodiments, the particles can have a dimension less than 100 microns, for example, 90 microns, 80 microns, 70 microns, 60 microns, 50 microns, 40 microns, 30 microns, 20 microns or 10 microns, or even less than 10 microns, for example 0.1 micron, 0.45 micron, 2.5 microns, 5 microns, 8 microns. The size of the particles in the fluid can also be described in US Patent Publication No. US 2006/0234572 A1.

When a fluid is introduced into the composite material according to the present invention, the fluid can intercalate into the porous matrix material. The term “intercalate” as used herein is intended to refer to the insertion of the fluid and/or particles between or among the layers of the porous matrix material. The fluid can be inserted into the porous matrix material via the plurality of the pores of the material. Depending on the type of the pores, the shear thickening fluid can be introduced into the pores or can pass through the pores of the porous matrix material. When the shear thickening fluid intercalates into the porous matrix material, the fluid can be quickly introduced and uniformly spread across the porous matrix material. In this context, the inventors have surprisingly found that the nature of the porous matrix material rapidly induces shear thickening in the fluid, due to the rapid movement of the porous matrix material when in use. This shear thickening is not localized within a specific area but occurs throughout the porous matrix material and the fluid-matrix interface.

In this context, in case a fluid, for example, a shear thickening fluid, is used in the present invention and is in contact with the ballistic material, the fluid may or may not intercalate into the ballistic fibre material, so long as the ballistic fibre material achieves its intended function of absorbing or resisting the impact of a moving object. However, in case the fluid. intercalates with the ballistic material, the fluid would always intercalate with ballistic material to a lesser extent, as compared to the intercalation of the fluid with the porous matrix material.

The term “openings” or “pores” as used herein refers to any holes, bores, apertures, spaces or intervals present in the porous matrix material. The pores can be interconnected to one another, and may or may not be accessible to fluid. In case the pores are accessible to fluid, they may permit fluid to pass through. The shape of the pores can typically be of any shape or size, and may depend on how the fibres are dispersed within the porous matrix material. The pores can typically have any sizes and can include sizes greater than that of the particles, so as to allow the particles of the fluid to pass through the pores of the porous matrix material. The characteristic of the pores, for example the porosity, pore diameter, pore volume, can be readily determined within the knowledge of the person of average skill in the art (See for example, Wang et al, Journal of Applied Polymer Science, 2006, vol. 102, pages 2264-2275 and Savel'eva E. K. et al, Fibre Chemistry, 2005, vol. 37, pages 202-204).

Without wishing to be bound by any theory, when a composite material of the present invention is subjected to an impact by a moving object such as a projectile, the initial point of impact can be absorbed by the ballistic material of the composite material, while the porous matrix material reinforces the ballistic material in reducing blunt trauma. In this context, it is believed that the shear thickening of the fluid that occurs throughout the porous matrix material and the fluid-matrix interface enables the layer of the ballistic material and the respective layer of porous matrix material to be held tightly together, when the composite material of the present invention is subject to ballistic impact for example. The shear thickening in the fluid and the tight (permanent) bonding between the ballistic material and the porous matrix material also prevent the ballistic material from being pushed into the porous matrix material, in which the fluid has been intercalated with. In this context, the inventors have found that the shear thickening of the fluid in the porous matrix material significantly increases the impact energy dissipation of the composite material. This impact energy is also dissipated by the breaking of the yarn of the ballistic material, upon ballistic impact. Due to the significant impact energy dissipation by the composite material, the deformation in the composite material caused by the impact was found to be significantly reduced. Therefore, blunt trauma caused by excessive deformation of the composite material can be effectively reduced, when the composite material is used for ballistic applications.

The use of the composite material when used in ballistic applications, for example a ballistic vest or a blunt trauma pad, has numerous advantages. As mentioned above, blunt trauma can be effectively reduced, thereby preventing injuries to the user. Furthermore, due to the effectiveness of the composite material in reducing deformation and blunt trauma, only a few stacks of a composite material of the present invention (in which 3 layers of ballistic material are bonded to the respective 3 layers of porous matrix material) are required. As a non-limiting example, 3 stacks of composite material in which 3 layers of ballistic material are bonded to the respective 3 layers of porous matrix material (2 cm thick) resulted in a significant reduction of deformation in the composite material. Therefore, the composite material of the invention is, able to prevent bulkiness and thereby increases flexibility and mobility when used for ballistic wear for example. On the other hand, a thicker composite material, for example, more than 3 stacks of composite material of the invention can also be used, when desired. In addition, the composite material remains soft and pliable when manipulated at low speed because the fluid that intercalates into the porous matrix material is able to flow within the matrix. This means that the composite material can be worn over parts of the body where mobility is important. Therefore, the composite material of the invention is exceptionally useful when used for ballistic purposes.

The present invention also relates to the use of a composite material for dissipating the kinetic energy of a moving object, for example, a projectile. The composite material of the invention can be used in different applications as long as it is able to provide protection from high impact force without compromising on mobility and flexibility. For example, the composite material can be used as industrial safety clothing for protecting workers in environments where sharp objects or projectiles could be encountered. The composite material can also be used for covering industrial equipment, such as equipment with high-speed rotating components, which could generate and release projectiles upon catastrophic equipment failure. The composite material can also be used as shrouding aircraft engines, to protect the aircraft and the occupants upon catastrophic failure of the engine. The composite material can also be used as a spall liner for vehicles such as automobiles, aircraft and boats, to protect the vehicle occupants by containing projectiles generated by a blunt or ballistic impact on the outside of the vehicle.

The composite material can be used in an article, in which any numbers of layers of ballistic material, can be stacked or placed adjacent to the composite material of the invention depending on the required design. The repeated layers of ballistic material are usually placed adjacent to the ballistic material which is bonded to the porous matrix material. Exemplary articles can include but are not limited to body armour, for example, flexible blunt trauma pads; bomb blanket; tank skirt; inflatable protective devices; or protective barrier. The protective barrier can be a stowable vehicle armour, tents, seats, cockpits, used in storage and transport of luggage or used in storage and transport ammunition. The article can also be protective clothing such as jackets, gloves, motorcycle protective clothing, pants, or boots, which could stiffen to provide bodily protection against blasts, such as those caused by exploding land mines, and sudden impacts such as those injured upon landing by parachute, or in accidents.

The present invention further relates to a process for making the composite material. The process includes bonding a layer of ballistic material to a layer of porous matrix material. The bonding can, for example, be carried out by applying an adhesive either on the ballistic fibre material or the porous matrix material and bringing the two layers of material in contact with each other for a suitable period of time. In this context, the ballistic material and the porous matrix material can be brought into contact with each other by any suitable means for example, by holding, clamping, stacking or applying pressure on the two layers.

As mentioned above, any suitable adhesives can be used to bond the materials together, so long as the ballistic material and the porous matrix are held tightly (permanently) together when in use. In this context, the adhesive can be of any form and is not limited to a liquid, putty-like, solid or the like. The adhesive can, for example, be a curable epoxy based adhesive. If an epoxy resin is used, an epoxy resin of bisphenol, hexahydrobisphenol, novolac, dimer acid, poly(ethylene glycol) or combinations thereof, can be used to bond the ballistic material to the porous matrix material. Alternatively, cyanoacrylate such as methyl-2-cyanoacrylate, ethyl-2-cyanoacrylate, also commonly known as “SuperGlue”, can be used to bond the ballistic material to the porous matrix material.

The process according to the invention further includes curing of the adhesive, in order to allow the ballistic material to be bonded to the porous matrix material. Curing generally occurs upon mixing of the epoxy with the curing agent. The curing process can be conducted in a temperature ranging from 0° C. to 200° C., from 5 to 80° C., or from 5 to 35° C. The optimal curing process can be determined empirically which is within the knowledge of the person of average skill in the art. As an illustrative example, the curing process can be conducted at room temperature for 8 hrs.

Epoxy curing agents in different forms, for example emulsion or dispersion form, are well known in the art. Examples thereof include hardeners of the dicyandiamide, imidazole, phenol, acid anhydride, acid hydrazide, fluorinated boron compound, aminimide, and amine types. These curing agents can be used alone or in combination of two or more thereof. During the curing step, for example, during the curing of epoxy resin, the curing-hardening agent is usually added in an amount that will provide one reactive —NH in the combined hardener-curing components for each epoxy group in the epoxy resin component. These are known in the art as stoichiometric quantities.

The process of the present invention can further include adding a fluid, for example, a shear thickening fluid to the composite material. Depending on the required design, any number of stacks of composite material of the invention can be made for this purpose. For example, the shear thickening fluid can be added to each stack of the composite material. In some embodiments, the composite material can be immersed in a suitable fluid, for example, the shear thickening fluid described herein. The final step of the process includes sealing the composite material by any suitable methods known to the person skilled in the art, so long as the composite material is enclosed within a structure, for example, an encapsulation. The encapsulated composite material can be sealed by any suitable methods, for example, by laminating both ends of the encapsulation together. In some embodiments, the composite material can be encapsulated in a polymer, latex, ceramics, or combinations thereof, under suitable heated conditions or by applying an adhesive to one end of the encapsulation in order to seal both ends of the encapsulation together. The adhesive can for example, be polyurethane, polyvinyl acetate, epoxy, cyanoacrylate such as methyl-2-cyanoacrylate, ethyl-2-cyanoacrylate, or combinations thereof. In this context, the encapsulated composite material can be of any shape or size, depending on the required design. For example, the encapsulated composite material can be in the form of a bag, a case or a sheet.

These aspects of the present invention and the advantages will be more fully understood in view of the following description of the drawings and the non-limiting examples.

### BRIEF DESCRIPTION OF THE DRAWINGS

In order to better understand the present invention and to demonstrate how it may be carried out in practice, preferred embodiments will now be described by way of non-limiting examples only, with reference to the accompanying drawings, in which:

FIG. 1A shows a schematic representation of an embodiment of the composite material according to the present invention, in which a layer of ballistic material (represented by stripes) is bonded to a layer of porous matrix material (represented by dots).

FIG. 1B shows a schematic representation of another embodiment of the composite material according to the invention. In this figure, 2 stacks of the composite material (represented by 2 layers of ballistic material bonded to the respective 2 layers of the porous matrix material) are encapsulated in latex. The composite material also contains shear thickening fluid (represented by the shaded portion) which intercalates into the porous matrix material.

FIG. 2 shows a schematic illustration of the ballistic setup used in the present invention.

FIG. 3 shows the indentation in clay placed behind different blunt trauma reduction materials, when a projectile was fired at the different blunt trauma reduction materials using the ballistic setup of FIG. 2. FIG. 3A shows the result of the indentation in clay which was placed behind 20 plies of Twaron® used as ballistic material. FIG. 3B shows the result of the indentation in clay which was placed behind 20 plies of Twaron® backed with a 2 cm rubber pad. FIG. 3C shows the result of the indentation in clay which was placed behind 20 plies of Twaron® backed with another 20 plies of Twaron®. FIG. 3D shows the result of the indentation in clay which was placed behind 20 plies of Twaron® backed with 3 stacks of the composite material of the present invention, in which 3 layers of ballistic material (Twaron®) are bonded to the respective 3 layers of porous matrix material (non-woven fibrous polyester) and are immersed in a suspension of corn starch (shear thickening fluid) within a latex encapsulation.

FIG. 4 shows the effects on the depth of penetration (mm) of different composite material upon ballistic impact, when various fluids were used in the composite material, with Twaron® used as ballistic material (represented by grey line). System A represents 1 ply of Twaron®. System B represents a composite material containing water (represented by dark grey box, 20 mm thick water) and 1 ply of Twaron®. System C represents a composite material containing a suspension of corn starch used as shear thickening fluid (represented by light grey box, 20 mm thick STF) and 1 ply of Twaron®.

FIG. 5 shows the effectiveness on the depth of penetration (mm) of a composite material according to the present invention (see System 3) upon ballistic impact, as compared to other composite material (see Comparative Systems 1 and 2). System 1 represents a composite material containing corn starch suspension as shear thickening fluid (represented by light grey box, 20 mm thick STF) and 1 ply of ballistic material (Twaron®, represented by grey line). System 2 represents a composite material containing 2 plies of ballistic material (Twaron®, represented by grey line) immersed in the shear thickening fluid and another 1 ply of the ballistic material (Twaron®, represented by grey line). System 3 represents 2 stacks of composite material of the invention immersed in the shear thickening fluid, in which 2 layers of ballistic material (epoxy treated Twaron® represented by black line) are bonded to the respective 2 layers of porous matrix material (non-woven fibrous polyester, represented by dotted line). An additional 1 ply of ballistic material (Twaron®, represented by grey line) is included in System 3.

FIG. 6 shows the effectiveness, on the depth of penetration (mm) of two different composite materials according to the present invention (see Systems 2 and 3) as compared to other composite materials (see Systems 1 and 4), upon ballistic impact. System 1 represents a composite material containing corn starch suspension as shear thickening fluid (represented by light grey box STF) and 2 plies of ballistic material (Twaron®, represented by grey line). System 2 represents 2 stacks of composite material immersed in the shear thickening fluid, in which 2 layers of ballistic material (epoxy treated Twaron® represented by black line) are bonded to the respective 2 layers of porous matrix material (non-woven fibrous polyester, represented by dotted line). An additional 2 plies of ballistic material (represented by grey line) are included in System 2. System 3 is similar to System 2, with the exception that water (represented by dark grey box) is used as fluid. System 4 is similar to System 2 with the exception that the ballistic material (Twaron® represented by grey line) in the composite material is not treated with epoxy but is stacked together with the porous matrix material (non-woven fibrous polyester, represented by dotted line).

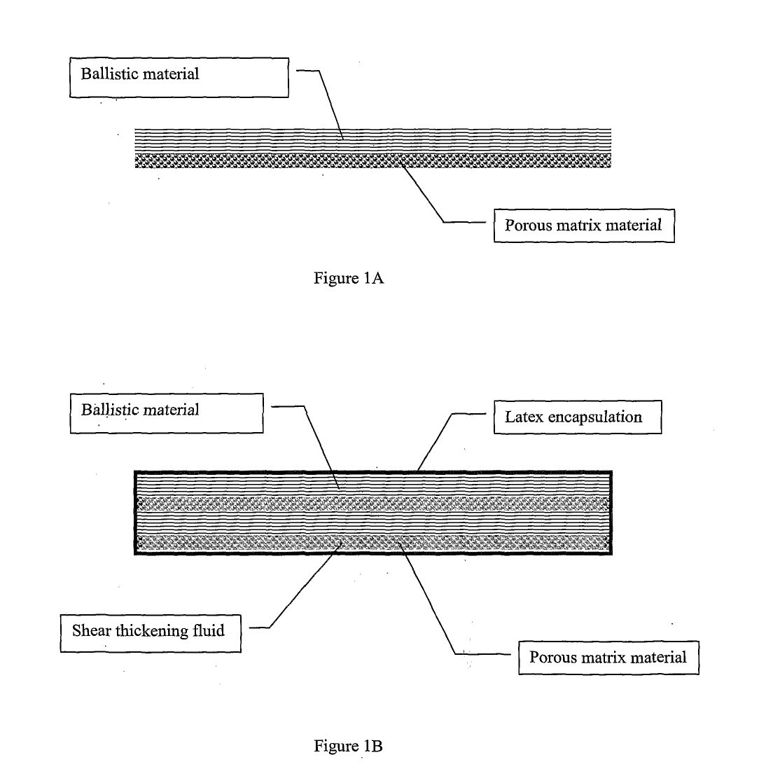

### EXAMPLES

### Example 1

This example illustrates materials used for preparing a composite material according to the present invention and a respective process.

The shear thickening fluid can for example, be a suspension of corn starch in water at a concentration of 55 wt. % as described in EE Bischoff White et al, Rheol Acta, 2010, vol. 49, pp. 119-129 or a dispersion of 450 nm silica particles in polyethylene glycol (PEG) at a volume fraction of 52% (v/v) as described in the Examples section of US Patent Publication No. US 2009/0004413 A1. In the following experiments, a suspension of corn starch in water at a concentration of 55 wt. % was used as shear thickening fluid. To prepare a composite material according to the invention, Twaron® fabric (obtained from Teijin Aramid) was used as ballistic material and non-woven fibrous polyester (RC3000-10AFR, obtained from Richmond Aircraft Products, Inc, USA) was used as porous matrix material. The Twaron® fabric was cut into 3 squares with a dimension of 15 cm by 15 cm in size. Corresponding pieces of non-woven fibrous polyester (RC3000-10AFR, obtained from Richmond Aircraft Products, Inc, USA) were also cut into the same size and shape as that of the Twaron® fabric. Epoxy adhesive (Araldite® 2011, obtained from Huntsman Advanced Materials, USA) was applied to one side of the Twaron® fabric. The non-woven fibrous polyester was brought into contact with the Twaron® fabric to allow both Twaron® and non-woven fibrous polyester to be bonded to each other. This was followed by curing of the adhesive at room temperature for 8 hours. Once the adhesive was cured, the 3 stacks of glued Twaron® fabric and non-woven fibrous polyester were inserted into a latex encapsulation. The shear thickening fluid was poured into the encapsulation, with the insertion of each stack of Twaron® fabric and fibrous polyester. Once the 3 stacks of the permanently bonded Twaron® fabric and non-woven fibrous polyester were immersed in the shear thickening fluid, the encapsulation was sealed by applying ethyl-2cyanoacrylate (Holdtite® CA25, obtained from Holdtite Adhesives, United Kingdom) on one end of the latex and bringing both ends of the latex into contact with each other, followed by curing of the cyanoacrylate at room temperature, thereby allowing the latex encapsulation to be permanently sealed.

### Example 2

This example illustrates the effectiveness in using a composite material in dissipating the high impact energy and the ability to reduce blunt trauma due to high energy ballistic impact. In this example, 3 stacks of composite material obtained from Example 1, in which 3 layers of Twaron® were bonded to the respective 3 layers of fibrous polyester and encapsulated in latex, were used (2 cm thick).

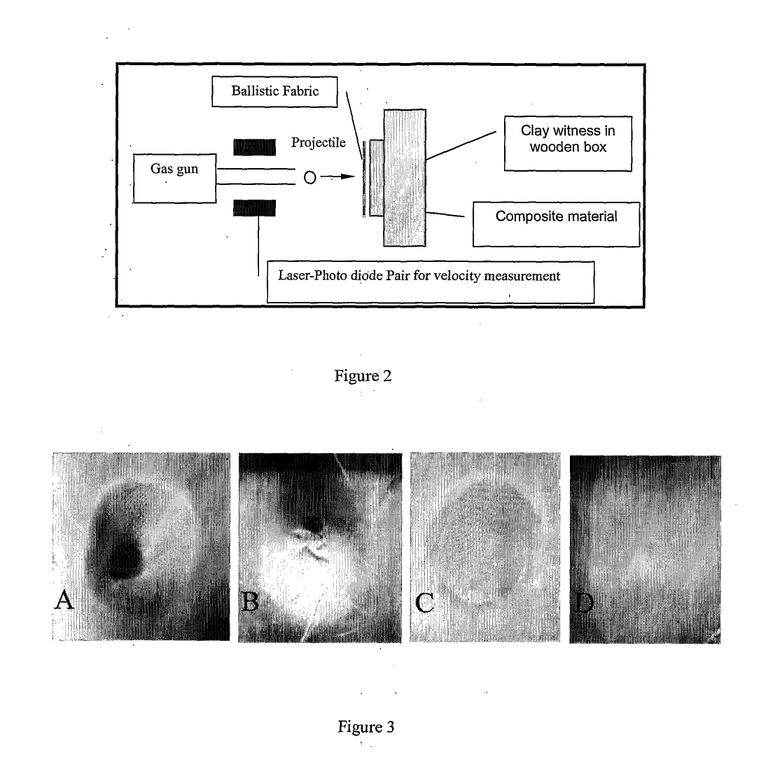

A schematic illustration of the ballistic testing setup was depicted in FIG. 2. Ballistic testing was performed using a gas gun. A spherical steel projectile was fired at 4 different blunt trauma reduction materials. The blunt trauma reduction materials were namely i) 20 plies of Twaron® used as ballistic material; ii) 20 plies of Twaron® backed with 2 cm rubber pad; iii) 20 plies of Twaron® backed with another 20 plies of Twaron®; and iv) 20 plies of Twaron® backed with 3 stacks of composite material obtained from Example 1. A box of plasticine clay witness placed behind each blunt trauma reduction material recorded the indentation caused by the impact. The velocity of the projectile was measured using a pair of sensors. The mass of the spherical steel projectile was 12 g and the impact velocity was 350 m/s. The impact energy of 735 J was equivalent to that of a NIJ (National Institute of Justice) standard IIIA (equivalent to the energy of a 9 mm bullet fired from a handgun).

The indentation in clay placed behind the 4 different blunt trauma reduction materials was depicted in FIG. 3. Although the projectile did not penetrate the 20 plies of Twaron®, the clay witness recorded deep indentation marks as the fabric was being pushed into the clay (see FIG. 3A). The indentation in clay of the remaining 3 blunt trauma reduction materials was depicted in FIGS. 3B to 3D respectively. The depth of the indentation (mm) in the clay witness using the 4 different blunt trauma reduction materials was measured and recorded in Table 1.

TABLE 1
Comparison of the depth of indentation in clay witness when
different blunt trauma reduction materials are used.

| | Depth of Indentation in | Percentage reduction in |
|---|---|---|
| Target | Clay Witness (mm) | blunt trauma |
| No target | Complete Penetration | N.A. |
| | through clay witness | |
| 20 layers Twaron | 35 (FIG. 3A) | N.A. |
| ballistic material | | |
| 20 layers Twaron | 14.35 (FIG. 3B) | 60 |
| ballistic material | | |
| backed with 2 cm | | |
| rubber pad | | |
| 20 layers Twaron | 21.56 (FIG. 3C) | 38 |
| ballistic material | | |
| backed with soft | | |
| trauma pad (made | | |
| of another 20 | | |
| layers Twaron) | | |
| 20 layers Twaron | 0 (FIG. 3D) | 100 |
| backed with 2 cm | | |
| composite material | | |

It is evident that the impact energy dissipation using the composite material of the invention (See FIG. 3D) described herein is superior compared to other blunt trauma reduction materials such as Twaron® (see FIGS. 3A and 3C) or rubber (see FIG. 3B).

### Example 3

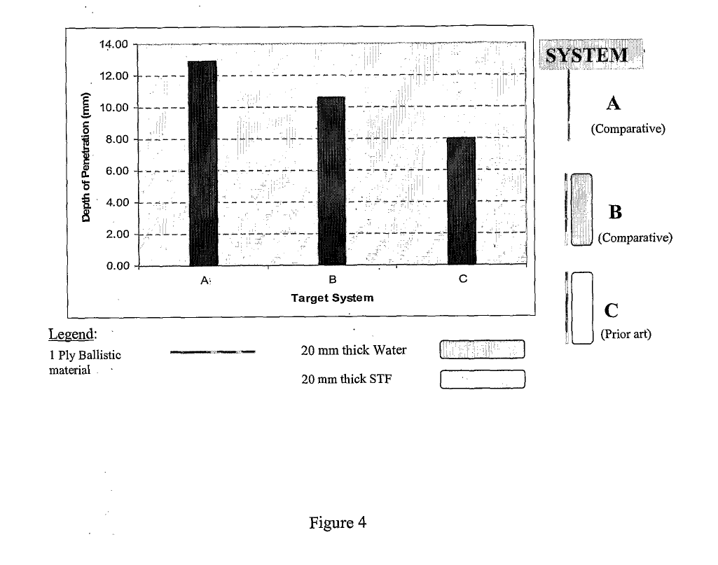

This example illustrates the effect of using various fluids in a composite material during high ballistic energy impact (see FIG. 4).

A spherical steel projectile of 14.5 mm in diameter was fired at three different composite systems. These systems were namely: i) 1 ply of Twaron® used as ballistic material (See FIG. 4, System A); ii) 1 ply of Twaron® and a composite material containing water encapsulated in latex (20 mm thick) (See FIG. 4, System B); and iii) 1 ply of Twaron® and a composite material containing a suspension of corn starch as shear thickening fluid (55 wt. %) encapsulated in latex (20 mm thick) (See FIG. 4, System C). The mass of the projectile was 12 g and the impact velocity was 75 m/s. The depth of penetration (mm) of each composite system was illustrated in FIG. 4. It is evident that the depth of penetration was lowest when shear thickening fluid was used. It is also noted in FIG. 4 that the depth of penetration was reduced when water was used as fluid in the composite material.

### Example 4

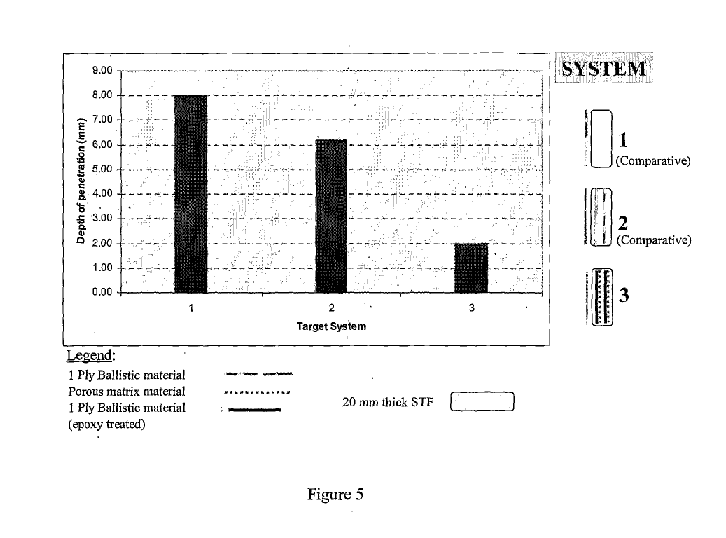

The present invention illustrates the effectiveness of a composite material of the invention when the non-woven fibrous polyester (porous matrix material) was used in the composite material, upon high ballistic energy impact (See FIG. 5).

A spherical steel projectile of 14.5 mm in diameter was fired at three different composite systems. These systems were namely: i) 1 ply of Twaron® used as ballistic material and a composite material containing a suspension of corn starch used as shear thickening fluid (55 wt. %) encapsulated in latex (20 mm thick) (see FIG. 5; System 1); ii) 1 ply of Twaron® and a composite material containing a suspension of corn starch used as shear thickening fluid (55 wt. %) in which 2 plies of Twaron® were immersed therein and encapsulated in latex (20 mm thick) (see FIG. 5; System 2); and iii) 1 ply of Twaron® and 2 stacks of composite material of the invention immersed in a suspension of corn starch used as shear thickening fluid (55 wt. %), in which 2 layers of Twaron® were bonded to the respective 2 layers of non-woven fibrous polyester by epoxy (Araldite® 2011) and encapsulated in latex (See FIG. 5; System 3). The mass of the projectile was 12 g and the impact velocity was 75 m/s. The depth of penetration (mm) of each composite system was illustrated in FIG. 5. As can be seen in FIG. 5, there was a significant reduction of the depth of penetration when the non-woven fibrous polyester was bonded to the respective layer of Twaron in the encapsulated composite material (See FIG. 5, System 3).

### Example 5

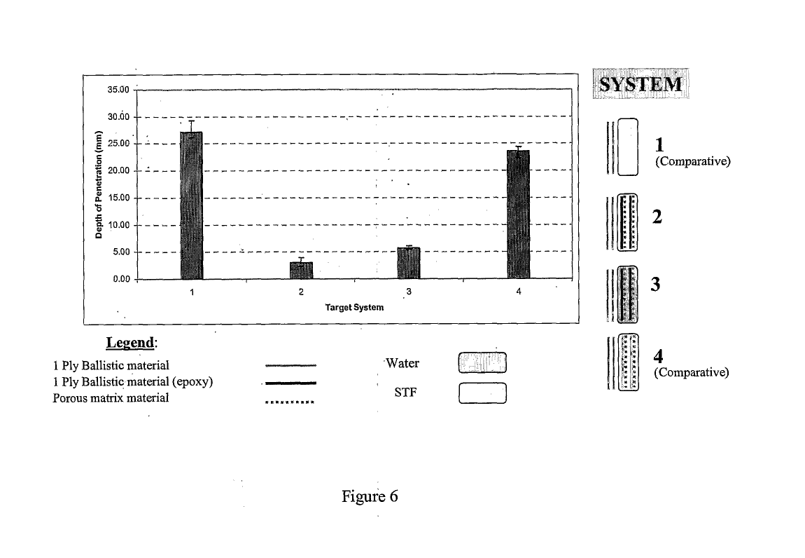

The present invention illustrates the effectiveness of a composite material of the invention during high energy ballistic impact, when an adhesive such as epoxy was used to bond the non-woven fibrous polyester (porous matrix material) to the Twaron® fabric (ballistic material). (see FIG. 6). FIG. 6 also illustrates the effect of the composite material of the invention when water was used as the fluid in the composite material.

A spherical steel projectile of 14.5 mm in diameter was fired at four different composite systems. These systems were namely: i) 2 plies of Twaron® and a composite material containing a suspension of corn starch used as shear thickening fluid (55 wt. %) which was encapsulated in latex (see FIG. 6; System 1); ii) 2 plies of Twaron® and a further 2 stacks of composite material of the invention immersed in a suspension of corn starch used as shear thickening fluid (55 wt. %), in which 2 plies of Twaron® were bonded to the respective 2 plies of non-woven fibrous polyester using epoxy (Araldite® 2011) and encapsulated in latex (see FIG. 5; System 2); iii) 2 plies of Twaron® and a further 2 stacks of composite material of the invention immersed in water in which 2 plies of Twaron were bonded to the respective 2 plies of non-woven fibrous polyester using epoxy (Araldite® 2011) (See FIG. 5; System 3); and iv) 2 plies of Twaron® and a further 2 stacks of composite material immersed in a suspension of corn starch used as shear thickening fluid (55 wt. %), in which 2 plies of Twaron® were brought into contact with the respective 2 plies of fibrous polyester by stacking.

The mass of the projectile was 12 g and the impact velocity was 145 m/s. The depth of penetration (mm) of each composite system was illustrated in FIG. 6. When comparing the depth of penetration between System 2 and System 4 in FIG. 6, it is evident that the depth of penetration of the composite material of the invention was significantly reduced when Twaron® was bonded to the fibrous polyester using epoxy (Araldite® 2011) in the encapsulated composite material (see System 2). In addition, it is noted that the depth of penetration of the composite material of the present invention was also reduced when water was used as the fluid in the encapsulated composite material (See System 3).

The listing or discussion of a previously published document in this specification should not necessarily be taken as an acknowledgement that the document is part of the state of the art or is common general knowledge. All documents listed are hereby incorporated herein by reference in their entirety.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or, not the excised material is specifically recited herein.

Other embodiments are within the following claims. In addition, where features or aspects of the invention are described in terms of Markush groups, those skilled in the art will recognise that the invention is also thereby described in terms of any individual member or subgroup of members of the Markush group.

What is claimed is:

1. A composite material able to dissipate the kinetic energy of a moving object, the composite material comprising a layer of ballistic material bonded to a layer of porous matrix material.

2. The composite material according to claim 1, further comprising a fluid, wherein the fluid intercalates into the porous matrix material.

3. The composite material according to claim 2, wherein the composite material is immersed in the fluid.

4. The composite material according to claim 2 or 3, wherein the fluid is an aqueous solution.

5. The composite material according to any one of claims 2 to 4, wherein the fluid is a shear thickening fluid.

6. The composite material according to any of claims 1 to 5, wherein the porous matrix material is a fibrous material.

7. The composite material according to claim any one of claims 1 to 6, wherein the porous matrix material is a non woven material.

8. The composite material according to any of claims 1 to 7, wherein the porous matrix material comprises a polymer.

9. The composite material according to any one of claims 1 to 8, wherein the polymer is selected from the group consisting of polypropylene, polyethylene, polymethylpentene, polybutene, poly(4-methyl-1-pentene), polyester and combinations thereof.

10. The composite material according to claim 9, wherein the polymer is polyester.

11. The composite material according to any one of claims 1 to 10, wherein the layer of ballistic material is bonded to the respective porous matrix material by an adhesive.

12. The composite material according to claim 11, wherein the adhesive is selected from the group consisting of polyurethane, polyvinyl acetate, epoxy and cyanoacrylate.

13. The composite material according to claim 12, wherein the adhesive is epoxy.

14. The composite material according to any one of claims 1 to 13, wherein the layer of ballistic material comprises a material selected from the group consisting of polyamide, polyolefin, polyimide, poly(p-phenylene-2,6-benzobisoxazole), carbon fibre, ceramic whisker, carbon nanotube reinforced polymer, glass reinforced polymer, microcrystalline cellulose and combinations thereof.

15. The composite material according to claim 14, wherein the polyamide is aramid, nylon or combinations thereof.

16. The composite material according to claim 15, wherein the aramid is poly paraphenylene terephthalamide or co-poly-(paraphenylene/3,4′-oxydiphenylene terephthalamide.

17. The composite material according to any one of claims 14 to 16, wherein the polyolefin is selected from the group consisting of ultra high molecular weight polyethylene (UHMWPE), high density polyethylene (HDPE), high modulus polypropylene (Innegra S®) and combinations thereof.

18. The composite material according to any one of claims 1 to 17, wherein the layer of ballistic material is in the form of a knitted fabric, a woven fabric, a non-woven fabric, uniweaved structure, a uni-directional sheet, a multi-directional sheet or a single fibre.

19. The composite material according to any one of claims 5 to 18, wherein the shear thickening fluid comprises particles suspended in a media.

20. The composite material according to claim 19, wherein the particles are organic or inorganic particles.

21. The composite material according to claim 19 or 20, wherein the particles are selected from the group consisting of oxides, corn starch, calcium carbonates, minerals, polymers and combinations thereof.

22. The composite material according to claim 21, wherein the oxides are selected from the group consisting of silicon dioxide, titanium oxide, silver oxide, zinc oxide, palladium oxide and combinations thereof.

23. The composite material according to claim 21, wherein the minerals are naturally occurring or synthetic occurring minerals.

24. The composite material according to claim 23, wherein the minerals are selected from the group consisting of quartz, calcite, talc, gypsum, kaolin, mica, silicon carbide and combinations thereof.

25. The composite material according to claim 21, wherein the polymer is poly(methyl methacrylate) or polystyrene.

26. The composite material according to any one of claims 19 to 25, wherein the particles have an average diameter size of less than 100 microns.

27. The composite material according to any one of claims 19 to 26, wherein the media is organic-based, aqueous-based or silicon-based.

28. The composite material according to claim 27, wherein the organic-based media is selected from the group consisting of ethylene glycol, polyethylene glycol, ethanol and combinations thereof.

29. The composite material according to claim 27, wherein the aqueous-based media comprises a salt.

30. The composite material according to claim 29, wherein the salt is sodium chloride, caesium chloride or mixtures thereof.

31. The composite material according to any one of claims 2 to 30 further comprising an anti-bacterial agent.

32. The composite material according to claim 31, wherein the silicon-based media is silicon oil, phenyltrimethicone, or combinations thereof.

33. The composite material according to any one of claims 1 to 32, comprising 5 layers of ballistic material bonded to the respective 5 layers of the porous matrix material.

34. The composite material according to any one of claims 1 to 33, wherein the composite material is encapsulated in latex.

35. A process for making the composite material according to any one of claims 1 to 34 comprising bonding a layer of fibre ballistic material with a layer of porous matrix material.

36. The process according to claim 35, further comprising adding a shear thickening fluid to the composite material.

37. The process according to claim 36, further comprising sealing the composite material.

38. The process according to any one of claims 35 to 37, wherein the bonding is carried out by applying an adhesive to either the ballistic material or the porous matrix material; bringing the materials in contact with each other; and curing the adhesive to allow the fibre ballistic material to be bonded with the porous matrix material.

39. The process according to claim 38, wherein the adhesive is a curable epoxy-based adhesive.

40. An article for dissipating the kinetic energy of a moving object comprising the composite material of any one of claims 1 to 34.

41. The article according to claim 40, wherein the article is selected from the group consisting, of body armour, bomb blanket, protective clothing, tank skirt and protective barrier.

42. Use of the composite material according to any one of claims 1 to 34 for dissipating the kinetic energy of a moving object.
